(19) United States
(12) Patent Application Publication
(10) Pub. No.: US 2020/0152077 A1
(43) Pub. Date: May 14, 2020

(54) GROUND-APPROACH FORCIBLE ENTRY TRAINING TRAILER

(71) Applicant: Jason Hamilton, Raleigh, NC (US)

(72) Inventor: Jason Hamilton, Raleigh, NC (US)

(21) Appl. No.: 16/185,079

(22) Filed: Nov. 9, 2018

(51) Int. Cl. G09B 19/00; A62C 99/00

(52) U.S. Cl. CPC G09B 19/00; A62C 99/0081

(57) ABSTRACT

The presently disclosed subject matter provides ground-approach forcible entry training trailers that comprise a trailer unit comprising a flatbed and at least two wheels; a frame connected to the trailer unit, wherein said frame is perpendicular to the flatbed and extends along a side edge of the flatbed; and a partial door hingedly connected to the frame, wherein said partial door comprises a locking mechanism at a standard height relative to the bottom of the wheels.

### FIELD

The present invention relates generally to the field of forcible entry door training props that allow demonstration, practice, and administration of forcible entry skill sets.

### BACKGROUND

Forcible entry door training props are used by firefighters to practice techniques for achieving forcible entry through a locked door. Examples of such practice techniques include training firefighters to use a Halligan tool by wedging it between the door and door jamb to pry a locked door open, a Flat head ax, a pry bar, a Pro bar, and a Hydro-Ram tool.

Conventional forcible entry door training props are free-standing props with a steel door and steel frame mounted on steel support footing, such as a base plate or bars. The problem with conventional forcible entry door training props is difficulty in transportation due to the enormous size and weight of the props. For example, to give perspective on the enormity of these props, a fully assembled forcible entry door training prop, commercially known as The Inforcer, weighs approximately 1,800 pounds.

One prior art solution to the problem is providing a forcible entry door training prop, such as the Multi-Force Forcible Entry Door Simulator (also commercially known as the Blue Door), that can be disassembled for transport and assembled on location. However, the Blue Door weighs roughly 770 pounds assembled; and due to the weight and size of the prop, transportation (including loading and unloading), disassembly and assembly on site can be labor-intensive and time-consuming.

Another prior art solution is reducing the weight of the prop by providing a forcible entry door training prop that only has a partial door (or even a hollowed out partial door) and frame mounted on support footing. While less heavy and easier to transport, these props lack stability when physical forces are exerted on the partial door and frame, especially when that partial door is hollow, and requires one to stand on the footing to keep the prop stable during use.

Mobile forcible entry door training props come in various forms. For example, the prop commercially known as the Challenger® is a forcible entry door training prop with a door and frame mounted on a base plate with two wheels, an arm with a third wheel that extends outwardly from the frame, and handle bars on the same side of the frame. The Challenger® can be tilted on its wheels and rolled, which helps transport the prop. However, at about 1,000 pounds, it is still labor-intensive to transport the Challenger® over long distances to a training destination, which would still require loading onto and unloading the prop from an automobile.

Another example of a mobile forcible entry door training prop is the prop commercially known as JTC breaching trailer, which provides a door and cage frame mounted to a trailer bed, and requires four leveling jacks at each corner of the trailer bed. Although the JTC breaching trailer is an easily transported and ready-to-use forcible entry door training prop, it presents issues with safety and user stability that is dependent on trailer stability.

Thus, there remains a need for a mobile forcible entry door training prop that is easy to transport, stable, and safe; and reduces time and labor associated with transportation, and training set-up and disassembly.

### SUMMARY OF THE INVENTION

The presently disclosed subject matter provides a ground-approach forcible entry training trailer comprising a trailer unit comprising a flatbed and at least two wheels; a frame connected to the trailer unit, wherein said frame is perpendicular to the flatbed and extends along a side edge of the flatbed; and a partial door hingedly connected to the frame, wherein said partial door comprises a locking mechanism at a standard height relative to the bottom of the wheels. In one embodiment, the locking mechanism is on the exterior side of the partial door. In another embodiment, the locking mechanism is on the interior side of the partial door. In one embodiment, the locking mechanism comprises a first retaining bracket disposed on the door, a second retaining bracket disposed on the frame and horizontally aligned to the first retaining bracket, and an elongated resistance member, wherein the first and second retaining brackets are configured to receive the elongated resistance member to simulate resistive forces of a locking device.

In another embodiment the ground-approach forcible entry training trailer further comprises a second frame connected to the trailer unit, wherein said second frame is perpendicular to the flatbed and extends along a second side edge of the flatbed; and a second partial door hingedly connected to the second frame, wherein said second partial door comprises a second locking mechanism at a standard height relative to the bottom of the wheels. In one embodiment, the second locking mechanism is on the interior side of the partial door.

In another embodiment, the ground-approach forcible entry training trailer further comprises a third frame connected to the trailer unit, wherein said third frame is perpendicular to the flatbed and extends along a third side edge of the flatbed; and a window subframe.

### BRIEF DESCRIPTION OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use the invention. In the drawings, like reference numbers indicate identical or functionally similar elements.

FIG. 1A is an exterior side view of an embodiment of a ground-approach forcible entry training trailer with an outward swinging partial door.

FIG. 1B is a front view of the ground-approach forcible entry training trailer with the outward swinging partial door.

FIG. 2A is a side view of an embodiment of a ground-approach forcible entry training trailer with an inward swinging partial door.

FIG. 2B is a front view of the ground-approach forcible entry training trailer with the inward swinging partial door.

FIG. 2C is a cross-section view of the ground-approach forcible entry training trailer showing the interior side of the inward swinging partial door with a locking mechanism.

FIG. 3 is a rear angle perspective view of an embodiment of a ground-approach forcible entry training trailer with an outward swinging partial door and an inward swinging partial door.

FIG. 4. is a rear angle perspective view of an embodiment of a ground-approach forcible entry training trailer with an outward swinging partial door, an inward swinging partial door, and a window sub-frame.

### DETAILED DESCRIPTION OF EMBODIMENTS

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein. The claimed subject matter might also be embodied in other ways, to include elements similar to the ones described in this document, in conjunction with other present or future technologies.

Embodiments of the present invention will now be described more fully hereinafter with reference to the accompanying drawings, in which some, but not all, embodiments of the invention are shown. Like numbers refer to like elements throughout. Other details of the embodiments of the invention should be readily apparent to one skilled in the art from the drawings. Although the invention has been described based upon these preferred embodiments, it would be apparent to those skilled in the art that certain modifications, variations, and alternative constructions would be apparent, while remaining within the spirit and scope of the invention.

The presently disclosed inventions provide numerous advantages, including, for example: easy transportation of a forcible entry door training prop between driving distances; elimination of extensive and labor-intensive assembly and disassembly of a forcible entry door training prop; increased safety of a forcible entry door training prop mounted to a trailer by providing ground-approach training; and reduced weight without compromising the stability of the prop or simulation of a locked door.

### Definitions

A “locking mechanism” includes, but is not limited to, pulls, latches, locks, deadbolts, other similar structures, and any device configured to simulate resistive forces of a locking device.

A “standard height” is a height within the range established by the International Building Code for egress door hardware height, or a height within the range of about 30 to 50 inches, and preferably within the range of about 34 to 48 inches.

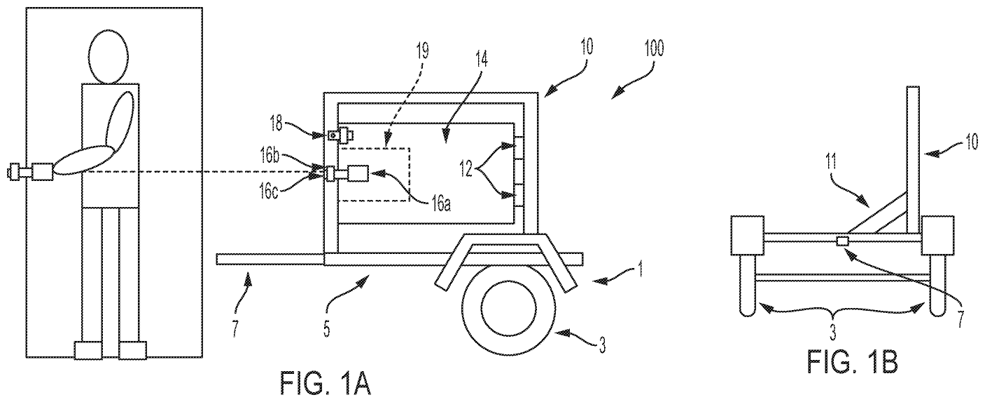

FIG. 1A is an exterior side view of an embodiment of a ground-approach forcible entry training trailer 100 with a trailer unit 1, a frame 10, an outward swinging partial door 14 (shown in a locked position), and a locking mechanism 16. The frame 10 as shown has two posts and an upper transverse member that enclose the sides and top of the outward swinging partial door 14. FIG. 1B is a front view of the ground-approach forcible entry training trailer 100 with the outward swinging partial door 14. The trailer unit 1 comprises a flatbed 5, at least two wheels 3, and a hitch 7. The frame 10 is perpendicular to the flatbed 5 and extends along a side edge of the flatbed 5. The frame 10 is connected to the trailer unit; for example, by welding the two structures together. One or more welded gussets 11 can be used to brace the frame 10. Other braces may be used, such as, but not limited to, gussets, lean-to braces, triangle braces, or other structures configured to support the frame in a perpendicular position relative to the frame and provide stability when physical forces are exerted on the partial door and/or frame. The outward swinging partial door 14 is hingedly connected to the frame with hinges 12. Other means may also be used to hingedly connect the partial door to the frame, including, for example drop in pins. The outward swinging partial door 14 has a length that is shorter than the customary length of a commercial door. The locking mechanism 16 secures the outward swinging partial door 14 in a closed position relative to the frame 10. The locking mechanism (16a, 16b, 16c) is at a standard height relative to the bottom of the wheels. The locking mechanism (16a, 16b, 16c) comprises a first retaining bracket 16a disposed on the outward swinging partial door 14, a second retaining bracket disposed 16b on the frame 10 and horizontally aligned to the first retaining bracket (16a), and an elongated resistance member 16c. The first and second retaining brackets, 16a and 16b respectively, are configured to receive the elongated resistance member 16c to simulate resistive forces of a locking device. A prying area 19 on the surface of the outward swinging partial door 14 can be outlined with paint. The prying area 19 provides guidance for the approximate area to practice techniques for achieving forcible entry through a locked door. A latch 18 can secure the outward swinging partial door 14 in a closed position relative to the frame 10 when the ground-approach forcible entry training trailer is not in use.

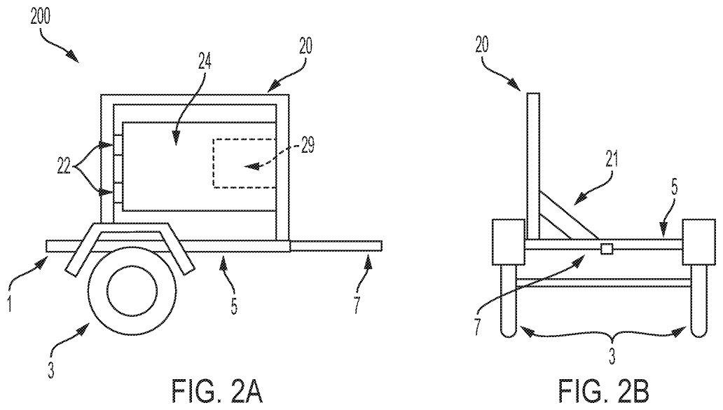

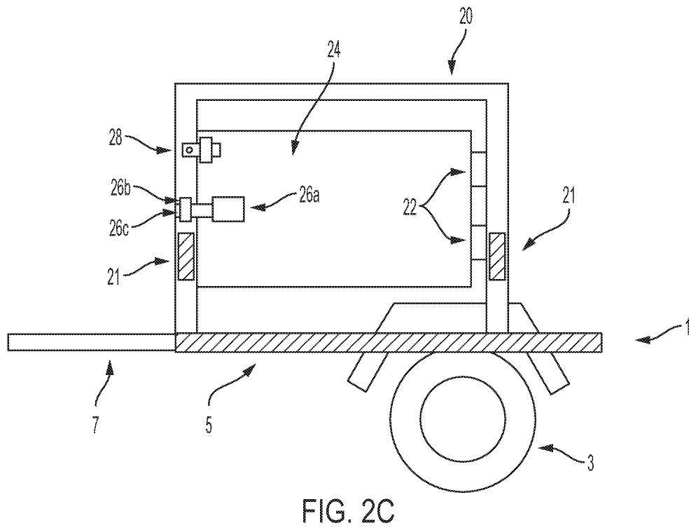

FIG. 2A is a side view of an embodiment of a ground-approach forcible entry training trailer 200 with a trailer unit 1, a frame 20, and an inward swinging partial door 24 (shown in a locked position). The frame 20 as shown has two posts and an upper transverse member that enclose the sides and top of the outward swinging partial door 24. FIG. 2B is a front view of the ground-approach forcible entry training trailer with the inward swinging partial door. The trailer unit 1 comprises a flatbed 5, at least two wheels 3, and a hitch 7. The frame 20 is perpendicular to the flatbed 5 and extends along a side edge of the flatbed 5. The frame 20 is connected to the trailer unit; for example, by welding the two structures together. One or more welded gussets 21 can be used to brace the frame 20. Other braces may be used, such as, but not limited to, cross-braces, lean-to braces, triangle braces, or other structures configured to support the frame in a perpendicular position relative to the frame and provide stability when physical forces are exerted on the partial door and/or frame. The inward swinging partial door 24 is hingedly connected to the frame with hinges 22. Other means may also be used to hingedly connect the partial door to the frame, including, for example drop in pins. The inward swinging partial door 24 has a length that is shorter than the customary length of a commercial door. A prying area 29 on the surface of the inward swinging partial door 24 can be outlined with paint. The prying area 29 provides guidance for the approximate area for to practice techniques for achieving forcible entry through a locked door.

FIG. 2C is a cross-section view of the ground-approach forcible entry training trailer showing the interior side of the inward swinging partial door 24 with a locking mechanism (26a, 26b, 26c) that secures the inward swinging partial door 24 in a closed position relative to the frame 20. The locking mechanism (26a, 26b, 26c) is at a standard height relative to the bottom of the wheels. The locking mechanism (26a, 26b, 26c) comprises a first retaining bracket (26a) disposed on the outward swinging partial door 24, a second retaining bracket (26b) disposed on the frame 20 and horizontally aligned to the first retaining bracket (26a), and an elongated resistance member (26c). The first and second retaining brackets are configured to receive the elongated resistance member to simulate resistive forces of a locking device. A latch 28 can secure inward swinging partial door 24 in a closed position relative to the frame 20 when the ground-approach forcible entry training trailer is not in use.

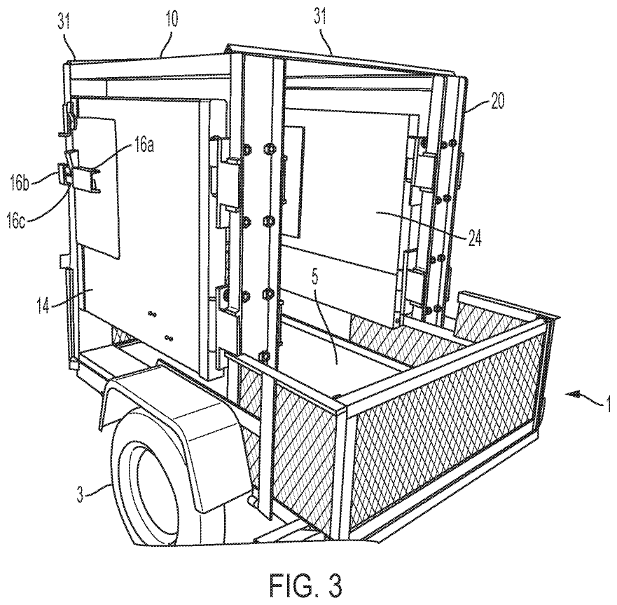

FIG. 3 is a rear angle perspective view of an embodiment of a ground-approach forcible entry training trailer 300 comprising a trailer unit 1 and the combination of an outward swinging partial door 14 and an inward swinging partial door 24. In this embodiment, a ground-approach forcible entry training trailer comprises a trailer unit 1 (comprising a flatbed 5 and two wheels 3 (one wheel on the opposite side of the flatbed not shown) and two frames 10, 20 that are perpendicular to the flatbed 5, wherein each frame extends along a different side edge of the flatbed 5. The frame 10 (with the outward swinging partial door 14 comprising an exterior-side locking mechanism (16a, 16b, 16c) extends along the right side edge of the flatbed 5. The frame 20 (with the inward swinging partial door 24 comprising an interior-side locking mechanism (not shown)) extends along the left side edge of the flatbed 5. As an alternative to welded gussets, two horizontal cross-braces, 31, each welded to both frames 10, 20 along the top of the frames, brace the frames. Other braces may be used, such as, but not limited to, gussets, lean-to braces, triangle braces, or other structures configured to support the frame in a perpendicular position relative to the frame and provide stability when physical forces are exerted on the partial door and/or frame. This embodiment enables multiple trainees to practice forcible entry skills simultaneously on either side of the trailer.

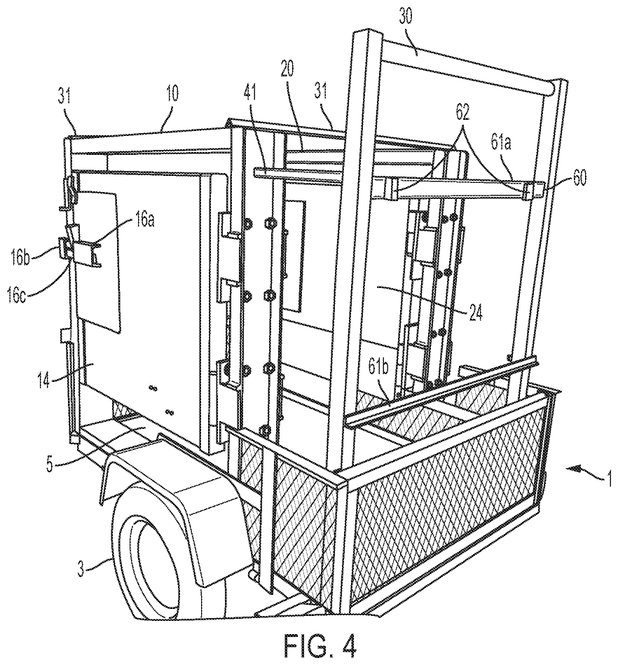

FIG. 4. is a rear angle perspective view of a further embodiment of a ground-approach forcible entry training trailer 400 comprising a trailer unit 1 and the combination of an outward swinging partial door 14, an inward swinging partial door 24, and a window sub-frame 60. In this embodiment, a ground-approach forcible entry training trailer comprises a trailer unit 1 (comprising a flatbed 5 and two wheels 3 (one wheel on the opposite side of the flatbed not shown) and three frames 10, 20, 30 that are perpendicular to the flatbed 5, wherein each frame extends along a different side edge of the flatbed 5. The frame 10 (with the outward swinging partial door 14 comprising an exterior-side locking mechanism (16a, 16b, 16c) extends along the right side edge of the flatbed 5. The frame 20 (with the inward swinging partial door 24 comprising an interior-side locking mechanism (not shown)) extends along the left side edge of the flatbed 5. Two horizontal cross-braces, 31, each welded to both frames 10, 20 along the top of the frames, brace the frames. The frame 30 extends along the rear side edge of the flatbed 5. The frame 30 is connected to the trailer; and reinforced, for example, by welding to the trailer unit and cross braces 41. Other braces may be used, such as, but not limited to, gussets, lean-to braces, triangle braces, or other structures configured to support the frame in a perpendicular position relative to the frame and provide stability when physical forces are exerted on the partial door and/or frame. The window sub-frame 60 comprises two horizontal frame members 61a and 61b welded to the frame 30. Two upper window brackets 62 are welded to the upper horizontal frame member 61a and spaced apart to receive a sheetrock in between the two window brackets 62. The lower horizontal frame member 61b has an “L” shape cross-section, such that the horizontal portion functions as a shelf. A sheetrock (not shown) with a width corresponding to the distance between the two upper window brackets 62 sits on the lower horizontal frame member 61b and rests between the two upper window brackets 62. The frame 30 can be outfitted with other standard equipment used for practicals known in the art, such as retaining devices (and any necessary threaded lock-in handle(s)) for a vertical rebar, horizontal rebar, lock cylinder, hinge, padlock, or chain.

Embodiments with multiple frames and multiple devices enables multiple trainees to practice forcible entry skills simultaneously and thus, reduces training and certification time.

While the embodiments have been described in connection with the preferred embodiments of the various figures, it is to be understood that other similar embodiments may be used or modifications and additions may be made to the described embodiment for performing the same function without deviating therefrom. Therefore, the disclosed inventions should not be limited to any single embodiment, but rather should be construed in breadth and scope in accordance with the appended claims.

What is claimed:

1. A ground-approach forcible entry training trailer comprising:
a trailer unit comprising a flatbed and at least two wheels;
a frame connected to the trailer unit, wherein said frame is perpendicular to the flatbed and extends along a side edge of the flatbed; and
a partial door hingedly connected to the frame, wherein said partial door comprises a locking mechanism at a standard height relative to the bottom of the wheels.

2. The ground-approach forcible entry training trailer of claim 1, wherein the locking mechanism is on the exterior side of the partial door.

3. The ground-approach forcible entry training trailer of claim 1, wherein the locking mechanism is on the interior side of the partial door.

4. The ground-approach forcible entry training trailer of claim 1, wherein the locking mechanism comprises:
a first retaining bracket disposed on the door,
a second retaining bracket disposed on the frame and horizontally aligned to the first retaining bracket, and
an elongated resistance member,
wherein the first and second retaining brackets are configured to receive the elongated resistance member to simulate resistive forces of a locking device.

5. The ground-approach forcible entry training trailer of claim 2, further comprising:
a second frame connected to the trailer unit, wherein said second frame is perpendicular to the flatbed and extends along a second side edge of the flatbed; and
a second partial door hingedly connected to the second frame, wherein said second partial door comprises a second locking mechanism at a standard height relative to the bottom of the wheels.

6. The ground-approach forcible entry training trailer of claim 5, wherein the second locking mechanism is on the interior side of the partial door.

7. The ground-approach forcible entry training trailer of claim 5, further comprising:
a third frame connected to the trailer unit, wherein said third frame is perpendicular to the flatbed and extends along a third side edge of the flatbed; and
a window subframe.
